(19) United States
(12) Patent Application Publication
(10) Pub. No.: US 2004/0148591 A1
(43) Pub. Date: Jul. 29, 2004

(54) Method, apparatus, and program for automated application context delivery to translators

(75) Inventors: David Bruce Kumhyr, Austin, TX (US); Joseph C. Ross, Georgetown, TX (US); Michael David Skibo, Austin, TX (US); Minto Tsai, Austin, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/351,561

(22) Filed: Jan. 23, 2003

(51) Int. Cl. G06F 9/45

(52) U.S. Cl. 717/137

(57) ABSTRACT

A mechanism is provided for associating text in resource files with program interface presentations. The mechanism also aggregates screen capture images and correlates them in a database. The mechanism includes a mock tool, which changes the text strings from their original form to an expanded string that allows for searching and unique identification. Screen captures may be made using the original code or the mock tool output by running through a script to generate each interface. A correlator tool associates the screen captures with related strings in the database. The screen captures and the correlator tool are provided to a translator along with the material to be translated. When the translator encounters a word or phrase that may be translated ambiguously, for example, the translator can paste or type the word or phrase into the correlator tool. The correlator tool will locate the word or phrase and present a screen image of the interface where the word or phrase is used.

### BACKGROUND OF THE INVENTION

1. Technical Field

The present invention relates to computer program development and, in particular, to multiple language program development. Still more particularly, the present invention provides a method, apparatus, and program for delivering application context information to translators.

2. Description of Related Art

When translating a literary work, such as a novel, the context for creating an accurate translation is derived from the work and the translator's understanding of the work's setting. For example, history, culture, location, and socioeconomic strata are important contextual details that must be understood when translating a novel. Context is an all-important aspect for understanding the work to be translated, and the basis from which an accurate translation arises, assuming the translator has the appropriate background and expertise.

Translation of software products is more difficult compounded by a number of factors. The setting of an application lies in the interfaces that communicate with the user. A translator may have little experience with the program content and the actual interfaces from which the context is derived.

Translation difficulty is also compounded by the developer's use of good internationalization practice. By moving the human language out of the program interface and into resource files, the text that is to be translated is disassociated from the interface. This leaves the translator to guess which text string in a file will be associated with which interface element.

Therefore, it would be advantageous to provide a mechanism for providing context information to translators in multiple language application development.

### SUMMARY OF THE INVENTION

The present invention provides a mechanism for associating text in resource files with program interface presentations. The mechanism also aggregates screen capture images and correlates them in a database. The mechanism includes a mock tool, which changes the text strings from their original form to an expanded string that allows for searching and unique identification. Screen captures may be made using the original code or the mock tool output by running through a script to generate each interface. A correlator tool associates the screen captures with related strings in the database. The screen captures and the correlator tool are provided to a translator along with the material to be translated. When the translator encounters a word or phrase that may be translated ambiguously, for example, the translator can paste or type the word or phrase into the correlator tool. The correlator tool locates the word or phrase and presents a screen image of the interface where the word or phrase is used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating a context delivery mechanism in accordance with a preferred embodiment of the present invention;

FIGS. 5A-5C are example screens of display for the context delivery mechanism of the present invention;

FIG. 6 is a flowchart illustrating the operation of a correlator tool for associating program source information with screen capture images in accordance with a preferred embodiment of the present invention; and

FIG. 7 is a flowchart illustrating the operation of a correlator tool for providing application context information to translators in accordance with a preferred embodiment of the present invention.

### DETAILED DESCRIPTION OF THE PREFERRED EMBODIMENT

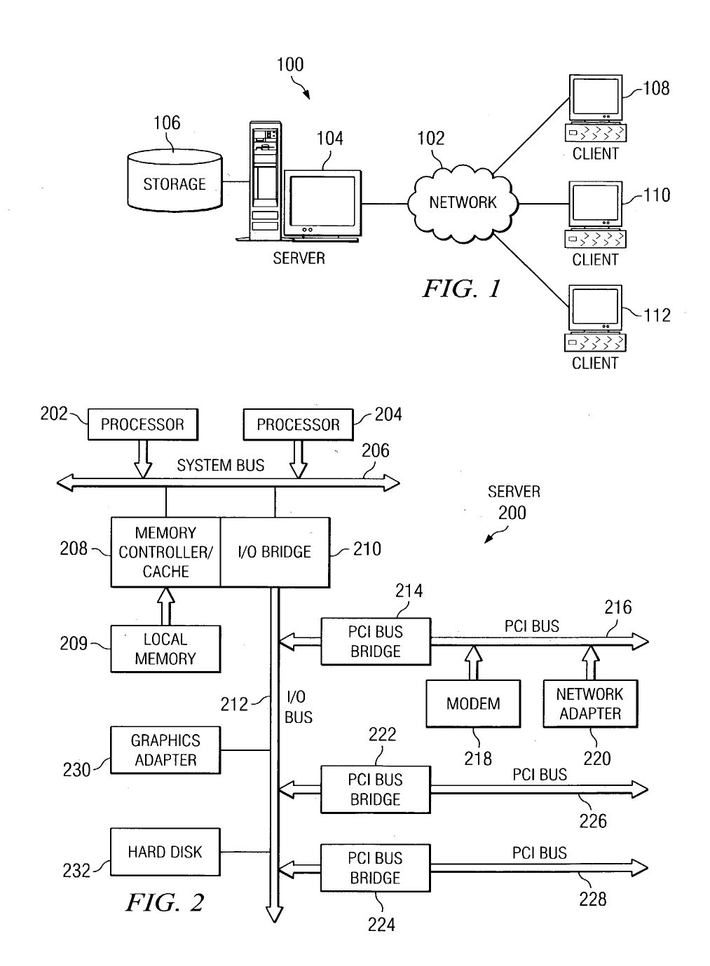

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 and provides access to storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages of course, network data processing system 100 also may be implemented as a number of different types of networks, such as for example, an intranet, a local area network (LAN), or a wide area network (WAN). FIG. 1 is intended as an example, and not as an architectural limitation for the present invention.

Software developers may provide application source and resource files at a client, such as one of clients 108, 110, 112. These files may be stored at the client workstation or at a server. For example, application source and resource files may be stored in storage 106. Server 104 may facilitate access to the files in storage 106 using, for example, File Transfer Protocol (FTP) or HyperText Transfer Protocol (HTTP).

Application files may be provided to a translator at a client, which may be another one of clients 108, 110, 112. The translator may receive application files through, for example, direct file transfer, electronic mail, or by download from server 104. Translation of software products becomes difficult due to a number of factors.

The setting of the application is determined through the creation of a plurality of interfaces that communicate information to a user. The translator may have little experience with such a setting.

Alternatively, the translator may understand software and be conversant with general computing, but lack specialized knowledge of the product area of the application, such as, for example, information technology management.

Translation difficulty may be compounded by the developer's use of good internationalization practice. By moving the human language out of the program interface and into resource files, the text that is to be translated becomes disassociated form the interface. This leaves the translator to guess which text string in a resource file will be associated with which interface element.

In accordance with a preferred embodiment of the present invention, a correlation tool is provided for associating text in resource files with program interface presentations. The correlation tool aggregates screen capture images and correlates them in a database. The correlator tool is provided at the translator's client workstation to allow a translator to search for text and to view the context in the product interface using the screen captures. When the translator encounters a word or phrase that may be translated ambiguously, the translator can paste or type the word or phrase into the correlator tool. The correlator tool will locate the word or phrase and present a screen image of the interface where the word or phrase is used.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

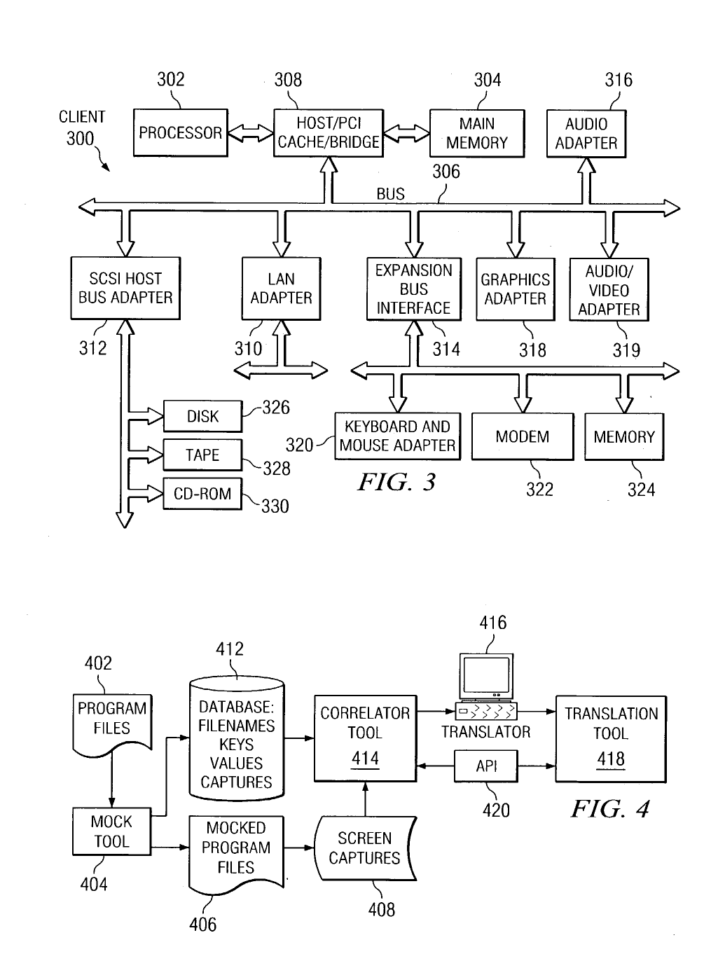

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference to FIG. 4, a block diagram illustrating a context delivery mechanism is shown in accordance with a preferred embodiment of the present invention. The application program files 402 are processed by mock tool 404. The mock tool, which may be a script, changes the text strings in the program files from their original form to an expanded string.

The expanded string may contain, for example, the filename of the source file and a key/value pair to enable the string to be found in the product source. For example, the text string “times” may be replaced with “scheduler.xml, key:repeatTimeSuffixValue, value:times.” Alternatively, the mock tool may generate a unique identifier (ID) for each string. The unique identifier may be generated based on the file name and key name. As an example, a text string may be replaced with “<ID>:<original_string>.” The use of a unique identifier allows a string to be located when the string appears in multiple source files or in multiple locations of the same source file.

The mock tool outputs all of these altered strings into output files that are stored in database 412. These output files may be parsed by correlator tool 414 so that the complete application interface is known to the correlator tool.

The mock tool may also generate mocked program files 406, which may be compiled. Screen captures 408 may be generated by running a defined set of test cases to display the program interface. Captures generated during this process may show the expanded text strings from mocked program files 406. The captured interface images may be aggregated into one directory or a Java Archive (JAR) file to allow for distribution without loss of organization.

Alternatively, for clearer interface images, screen captures 408 may be generated using original program files 402. This would eliminate the problem of screen noise caused by possible truncation of expanded text strings when the interfaces are rendered.

Following screen capture, correlator tool 414 is used to associate the name of each capture with the related strings in the database. The screen captures may be generated automatically using a script to run through the possible interface instances. The screen captures may be associated with the text strings automatically using optical character recognition (OCR).

The correlator tool and the screen captures may then be provided to translator 416 along with the material to be translated. When the translator encounters a word or phrase that may be translated ambiguously, the translator may search for the word or phrase using the correlator tool. If the word or phrase is found, the correlator tool may present the screen image of the product where the text is used, thus providing a context for the word or phrase.

In addition, the translator may perform the actual translation using translation tool 418. The translator may use correlator tool 414 as a separate reference tool. As such, the translator must cut-and-paste or manually type text strings between the translation tool and the correlator tool. In a preferred embodiment of the present invention, Application Program Interface (API) 420 is provided between correlator tool 414 and translation tool 418 to allow text strings to be searched without the manual and error prone steps of manually transferring text strings between the correlator tool and the translation tool. Using API 420, an a menu item may be appended to the interface of the translation tool to allow a quick look-up showing a context image of the use of a term or phrase. For example, if a translator using the translation tool encounters a phrase and wants to see it in context, the translator may select a menu item appended to the menu bar, such as “Look up in context . . . ,” and this selection invokes correlator tool 414 to present the appropriate screen capture image.

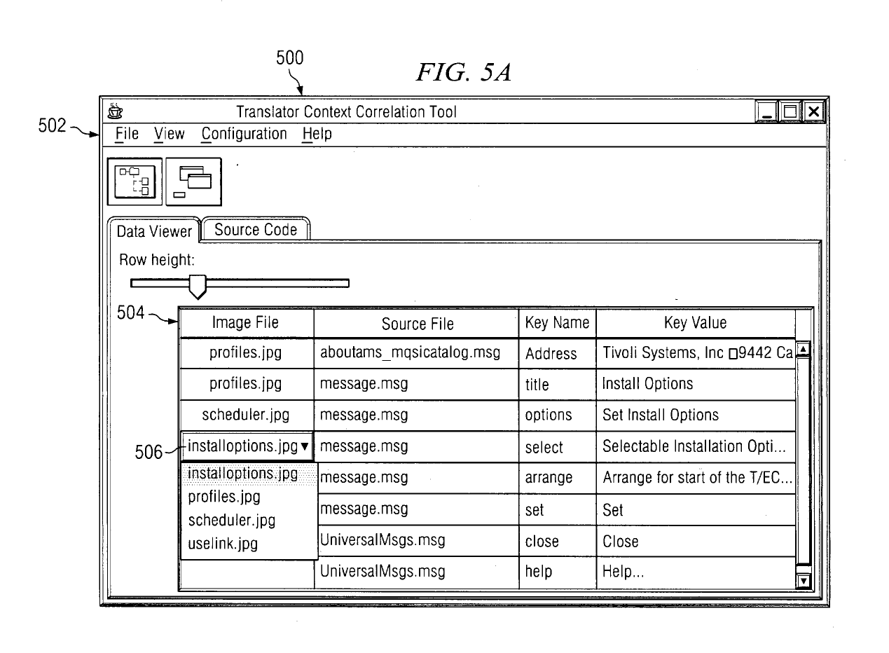

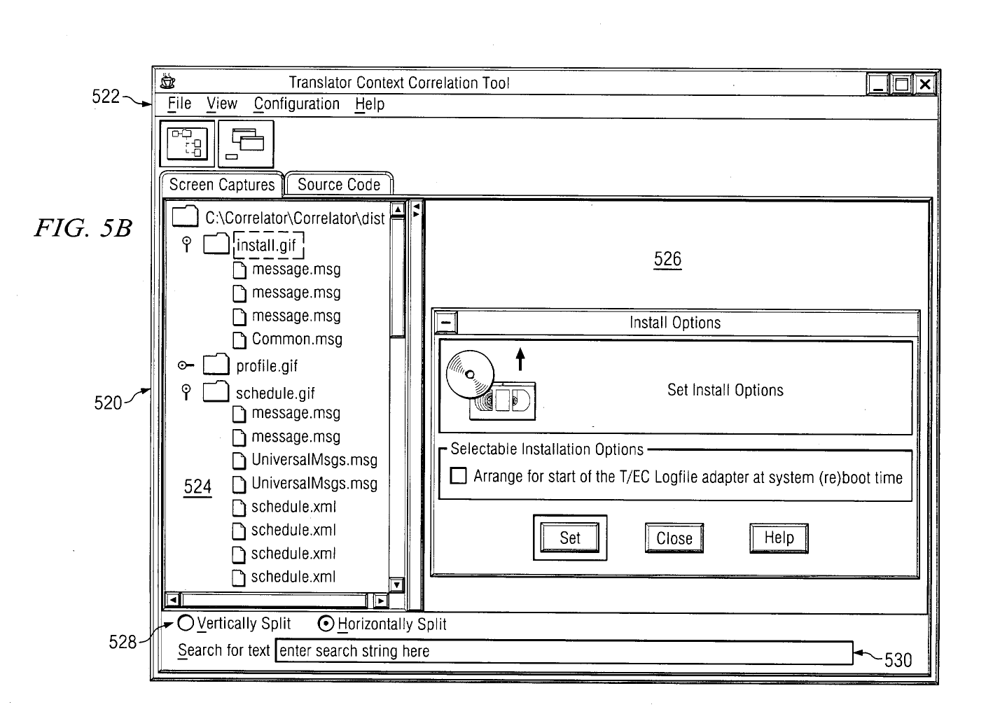

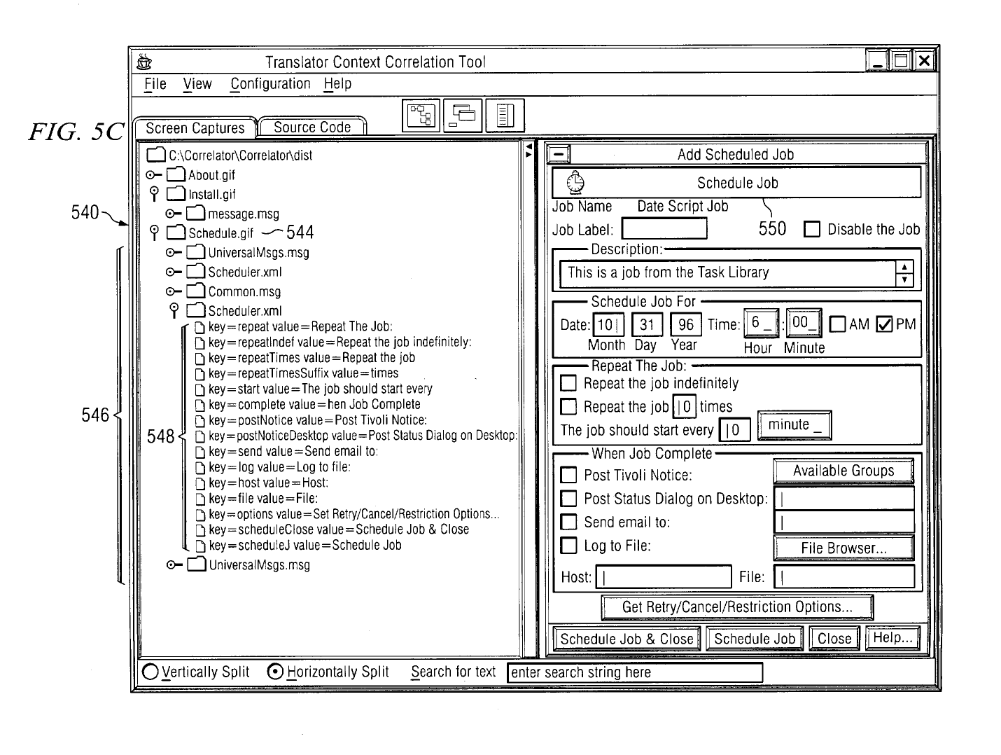

FIGS. 5A-5C are example screens of display for the correlator tool of the present invention. More particularly, FIG. 5A illustrates a screen of display for associating screen captures with expanded text strings in accordance with a preferred embodiment of the present invention. The screen comprises window 500, including menu bar 502. Menus to be selected from menu bar 502 may include “File,” “View,” “Configuration,” and “Help.” However, menu bar 502 may include fewer or more menus, as understood by a person of ordinary skill in the art.

The correlator tool window display area includes an association area 504 which includes columns for “Image File,” “Source File,” “Key Name,” and “Key Value.” The correlator tool may parse mock output files to populate the “Source File,” “Key Name,” and “Key Value” fields for each text string. Alternatively, these values may be manually entered by a user. For each image file, a user may select a screen capture file in “Image File” field 506. This field may be presented as a drop-down box, for example, as shown in FIG. 5A. When this association process is complete, the aggregated information is stored in a file that is displayed by the correlator to the translator for searching and reference.

Turning now to FIG. 5B, a screen of display for a correlation view in accordance with a preferred embodiment of the present invention. The screen comprises window 520, including menu bar 522. Menus to be selected from menu bar 522 may include “File,” “View,” “Configuration,” and “Help.” However, menu bar 522 may include fewer or more menus, as understood by a person of ordinary skill in the art.

The correlator tool window display area includes a screen capture data area 524 and a screen capture image area 526. A translator may navigate the screen capture data and identify a screen capture of interest. In the example shown in FIG. 5B, the screen capture data is presented in a hierarchical tree structure.

When the user identifies a screen capture of interest, the user may select the screen capture for display in screen capture image area 526. The user may also expand the screen capture file in screen capture data area 524 to present the source files associated with that screen capture. In addition, the user may expand a source file to present text strings associated with the source file.

The screen capture data area and screen capture image area may be displayed as vertically split, horizontally split, or in any other orientation, such as, for example, separate cascaded or tiled windows. In the example shown in FIG. 5B, the user may select whether the screen capture data are and screen capture image area are vertically split or horizontally split using radio buttons 528.

Correlator window 520 also includes search field 530, which allows a user to search for a given text string or fragment of a string. A text string that contains the string of fragment may be identified in screen capture data area 524 and the associated interface image may be displayed in screen capture image area 526.

With reference now to FIG. 5C, example correlator tool window 540 is shown. The correlator tool provides the translator with a database of text as well as a presentation facility for displaying images of the interfaces. The translator may search the database for a string or fragment of a string and be shown the interface that uses the string. The screen capture data may also identify if a string is used in multiple source files or in multiple locations within a file. Multiple use messages may be flagged using a graphical icon (not shown) in the tree view of the screen capture data area.

In the example shown in FIG. 5C, correlator window 540 includes a screen capture data area that presents a plurality of image files, including “About.gif,” “Install.gif,” and “Schedule.gif.” In this example, image file 544, “Schedule.gif,” is expanded to present associated source files 546. An instance of “Scheduler.xml” is expanded to illustrate the text strings 548 associated with this source file. In the screen capture image area, the image of “Schedule.gif” 550 is presented.

Thus, the translator can easily navigate the screen capture data information to identify a source file or even a text string. The translator may then select a screen capture image file to be displayed in the screen capture image area. The translator may also search the database to identify a source file and text string that matches a search expression. The translator may then view the interface image, which provides a context for translation.

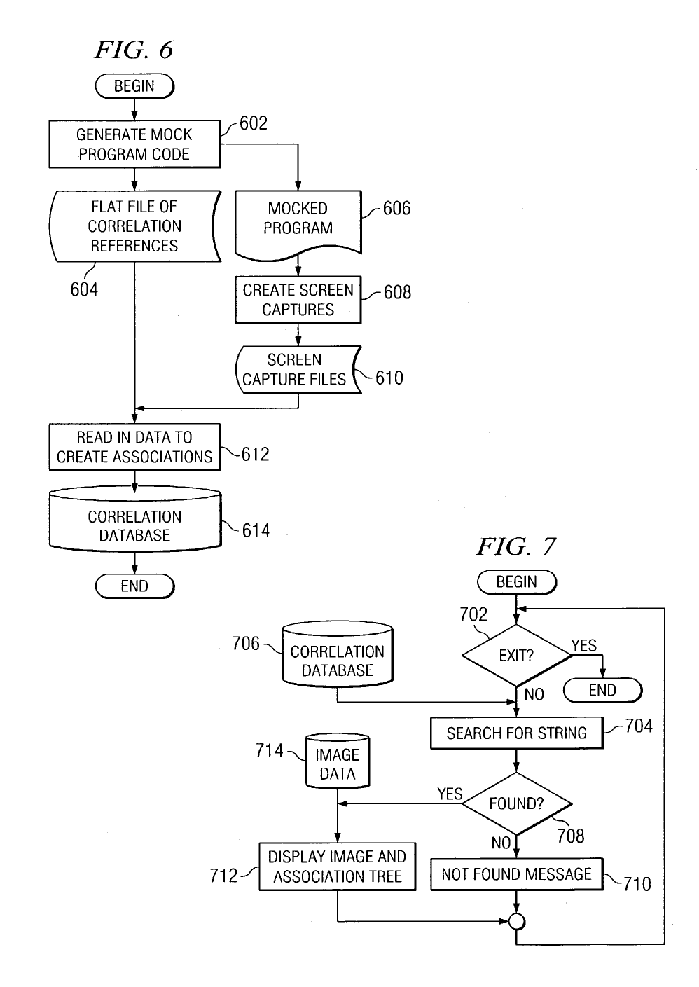

With reference to FIG. 6, a flowchart illustrating the operation of a correlator tool associating program source information with screen capture images is shown in accordance with a preferred embodiment of the present invention. The process begins and generates mock program code (step 602). The mock tool generates mocked program 606 and a flat file of correlation references 604. The process then creates screen captures (step 608) to generate screen capture files 610. Next, the process reads in the file of correlation references and screen capture files to create associations (step 612). The correlation information is stored in correlation data base 614. Thereafter, the process ends.

With reference now to FIG. 7, a flowchart illustrating the operation of a correlator tool for providing application context information to translators is shown in accordance with a preferred embodiment of the present invention. The process begins and a determination is made as to whether an exit condition exists (step 702). An exit condition may exist, for example, if a user closes the correlator tool window or otherwise exits the correlator tool. If an exit condition exists, the process ends.

If an exit condition does not exist in step 702, the process searches for a string (step 704). The search string may be received through a search field presented in the correlator tool window. The search is performed against correlation database 706. Next, a determination is made as to whether a match is found in the correlation database (step 708).

If a match is not found, the process returns a message indicating that the search string is not found (step 710). Then, the process returns to step 702 to determine whether an exit condition exists.

If a match is found in step 708, the process displays an image and association tree (step 712). Images are retrieved from image data 714. Then, the process returns to step 702 to determine whether an exit condition exists.

Thus, the present invention solves the disadvantages of the prior art by providing a mechanism for associating text in resource files with program interface presentations. Without understanding of context the possibility of inaccurate translation can rise dramatically. Using the process of the present invention, a useful context is provided to the translator, which reduces the initial translation defects. If the initial translation goes through spell checking and grammar checking followed by an edit proof reading, the resulting translation can possibly be of high enough quality to ship without translation verification testing. Thus, the present invention may save a considerable cost and time associated with translation verification testing.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing a context for a program to be translated, wherein the program has one or more program files, the method comprising:
generating a mock output for the one or more program files, wherein each text string in the one or more program files is replaced with an extended text string in the mock output;
generating a plurality of screen captures for the program; and
associating each extended text string in the mock output with a corresponding one of the plurality of screen captures to form correlation data.

2. The method of claim 1, wherein the mock output includes one or more mocked program files.

3. The method of claim 2, wherein the step of generating a plurality of screen captures includes generating the plurality of screen captures using the mocked program files.

4. The method of claim 1, wherein each extended text string includes a program file name, a key name, and a key value.

5. The method of claim 1, wherein each extended text string includes a unique identifier.

6. The method of claim 1, wherein the step of generating a plurality of screen captures includes running a script to run through possible interfaces.

7. The method of claim 1, further comprising:
storing the plurality of screen captures in one of a directory and a Java Archive file.

8. The method of claim 1, wherein the mock output includes a correlation data file.

9. The method of claim 8, further comprising:
parsing the correlation data file to identify correlation data in the extended text strings.

10. The method of claim 1, further comprising:
providing the correlation data and the plurality of screen captures to a translator.

11. The method of claim 10, further comprising:
receiving from the translator a text search expression;
searching correlation data for the text search expression;
responsive to the text search expression matching a text string in the correlation data, identifying a screen capture image associated with the text string; and
presenting the screen capture image to the translator.

12. A method for providing a context for a program to be translated, wherein the program has one or more program files, the method comprising:
receiving a text search expression;
searching correlation data for the text search expression;
responsive to the text search expression matching a portion of a text string in the correlation data, identifying a screen capture image associated with the text string; and
presenting the screen capture image.

13. An apparatus for providing a context for a program to be translated, wherein the program has one or more program files, the apparatus comprising:
mock output means for generating a mock output for the one or more program files, wherein each text string in the one or more program files is replaced with an extended text string in the mock output;
screen capture means for generating a plurality of screen captures for the program; and
association means for associating each extended text string in the mock output with a corresponding one of the plurality of screen captures to form correlation data.

14. The apparatus of claim 13, wherein the mock output includes one or more mocked program files.

15. The apparatus of claim 14, wherein the screen capture means includes means for generating the plurality of screen captures using the mocked program files.

16. The apparatus of claim 13, wherein each extended text string includes a program file name, a key name, and a key value.

17. The apparatus of claim 13, wherein each extended text string includes a unique identifier.

18. The apparatus of claim 13, wherein the screen capture means includes means for running a script to run through possible interfaces.

19. The apparatus of claim 13, wherein the mock output includes a correlation data file.

20. The apparatus of claim 19, further comprising:
means for parsing the correlation data file to identify correlation data in the extended text strings.

21. An apparatus for providing a context for a program to be translated, wherein the program has one or more program files, the apparatus comprising:
means for receiving a text search expression;
means for searching correlation data for the text search expression;
means, responsive to the text search expression matching a portion of a text string in the correlation data, for identifying a screen capture image associated with the text string; and
means for presenting the screen capture image.

22. A computer program product, in a computer readable medium, for providing a context for a program to be translated, wherein the program has one or more program files, the computer program product comprising:
instructions for generating a mock output for the one or more program files, wherein each text string in the one or more program files is replaced with an extended text string in the mock output;
instructions for generating a plurality of screen captures for the program; and
instructions for associating each extended text string in the mock output with a corresponding one of the plurality of screen captures to form correlation data.

23. A computer program product, in a computer readable medium, for providing a context for a program to be translated, wherein the program has one or more program files, the computer program product comprising:
instructions for receiving a text search expression;
instructions for searching correlation data for the text search expression;
instructions, responsive to the text search expression matching a portion of a text string in the correlation data, for identifying a screen capture image associated with the text string; and
instructions for presenting the screen capture image.
